(19) United States
(12) Patent Application Publication
(10) Pub. No.: US 2026/0116386 A1
(43) Pub. Date: Apr. 30, 2026

(54) TOWING MODE CONTROL SYSTEM OF VEHICLE AND METHOD THEREFOR

(71) Applicants: Hyundai Motor Company, Seoul (KR); Kia Corporation, Seoul (KR)

(72) Inventor: Se Jun PARK, Hwaseong-si (KR)

(73) Assignees: Hyundai Motor Company, Seoul (KR); Kia Corporation, Seoul (KR)

(21) Appl. No.: 19/054,006

(22) Filed: Feb. 14, 2025

(30) Foreign Application Priority Data
Oct. 29, 2024 (KR) 10-2024-0149339

(51) Int. Cl. B60W 30/18

(52) U.S. Cl. CPC B60W 30/18127; B60W 2300/14; B60W 2530/10; B60W 2710/083

(57) ABSTRACT

A towing mode control system of a vehicle includes a driving information detector configured to detect, while a towing vehicle is towing a towed vehicle in a state where the towing vehicle and the towed vehicle are connected by a towing device to communicate with each other by a communication device, vehicle driving information of the towing vehicle, in the towing vehicle, and a controller configured to receive the vehicle driving information of the towing vehicle transmitted from the towing vehicle and estimate a total weight of the towing vehicle and the towed vehicle based on the vehicle driving information of the towing vehicle and vehicle driving information of the towed vehicle, in which the motor regenerative torque of the towed vehicle according to the estimated total weight during towing of the towed vehicle, and a method therefor.

### CROSS-REFERENCE TO RELATED APPLICATION

The present application claims priority to Korean Patent Application No. 10-2024-0149339 filed on Oct. 29, 2024, the entire contents of which is incorporated herein for all purposes by this reference.

### BACKGROUND OF THE PRESENT DISCLOSURE

### Field of the Present Disclosure

The present disclosure relates to a towing mode control system of a vehicle, configured for solving the problem of insufficient acceleration and starting feeling of a vehicle due to EV towing charging in the case of heavy-weight towing and towed vehicles, and a method therefor.

### Description of Related Art

An eco-friendly vehicle is a vehicle that utilizes electric power for driving and traveling, and utilizes a motor as a drive unit that drives the vehicle.

Such an eco-friendly vehicle is provided with a motor that generates driving force, an inverter for driving and controlling the motor, and an energy storage system (ESS) that stores electrical energy to drive the motor, as main power components thereof.

The inverter is an important component that controls current applied to the motor, and the energy storage system is a main source of electrical energy, which may include a typical high-voltage battery mounted in the eco-friendly vehicle.

In such an eco-friendly vehicle that is driven by electric power (i.e., by the motor), the battery of the energy storage system is connected to the motor via the inverter to be charged and discharged.

In the motor-driven vehicle, regenerative braking may be performed during braking or coasting the vehicle, using the motor as a generator to recover vehicle kinetic energy as electrical energy during braking or coasting the vehicle.

That is, the motor is operated as a generator with rotational power of driving wheels to generate electrical energy, and the battery is charged with the generated electrical energy.

In a case where an owner having two or more vehicles wants to use all the vehicles at a desired destination, the owner may use a neutral towing function to take all the vehicles to the desired destination.

For example, one vehicle among the two or more vehicles may be designated as a towing vehicle, and another vehicle among the two or more vehicles may be designated as a towed vehicle connected to the rear of the towing vehicle. The towing vehicle and the towed vehicle may be connected to each other using a towing device such as a tow bar, and then move together to the desired destination.

Here, in the towing vehicle, driving power for driving is generated, and in the towed vehicle, a gear is set to neutral (N), so that the towing vehicle moves in front of the towed vehicle and pulls the towed vehicle.

The neutral towing function is a function for allowing the towed vehicle to be towed easily by setting the gear of the towed vehicle to neutral (N) and keeping the towed vehicle in an unloaded state.

Recently, when towing an electric vehicle (EV) capable of performing regenerative braking by connecting the electric vehicle as a towed vehicle to a towing vehicle, a flat tow mode for performing EV towing charging by charging a battery using the regenerative braking of the electric vehicle, which is the towed vehicle, has been provided.

For example, when connecting an electric vehicle (EV) as a sub-vehicle to a camper van and towing in a flat tow mode, a battery of the EV may be charged using regenerative braking of the electric vehicle that is a towed vehicle.

FIG. 1 is a diagram illustrating an EV towing charging state in which a battery is charged through regenerative braking control in an electric vehicle (EV), which is a towed vehicle 200, in a case where a towing vehicle 100 tows the EV in a flat tow mode.

The flat tow mode is a towing mode in which the towing vehicle 100 tows the towed vehicle 200 in a state where all four wheels of the towed vehicle 200 are grounded as shown in FIG. 1, and in a case where the towed vehicle 200 is an electric vehicle, EV towing charging may be performed.

Generally, when towing an electric vehicle, since there is a risk of damage to Power Electric (PE) parts of the electric vehicle, it is recommended to tow the electric vehicle with its wheels not touching the ground.

When using the flat tow mode, the towing vehicle 100 and the towed vehicle 200 are connected via a towing device, and a user (driver) turns on the engine of the towed vehicle 200 (“EV Ready”), and then selects and activates the flat tow mode via an Audio, Video and Navigation (AVN).

Here, a target State of Charge (SOC) may be set in the towed vehicle 200.

Then, in a case where the driver enters the towing vehicle 100 and starts driving the towing vehicle 100, the control for the flat tow mode starts in the towed vehicle 200, and then, during the flat tow mode in which the vehicle is towed, a battery of the towed vehicle may be charged to the target SoC through the regenerative braking control of the electric vehicle that is the towed vehicle 200.

Here, the electric vehicle (towed vehicle) connected by the towing device is set to the neutral (N) state, and when being towed by the towing vehicle 100 in the neutral state, the electric vehicle, which is the towed vehicle 200, travels in a coasting manner.

In the present way, in a case where the electric vehicle is coasting, the battery of the electric vehicle, which is the towed vehicle 200, may be charged while performing regenerative braking by the motor through Pulse Width Modulation (PWM) control of the motor.

However, when charging the battery of the towed vehicle using the flat tow mode, a regenerative braking force generated in the towed vehicle during battery charging generates a pulling force in the opposite direction of the vehicle's traveling direction in the towing vehicle.

Here, in a case where the weight of the towing vehicle is large, a phenomenon may occur that the vehicle's driving force becomes insufficient compared to the regenerative braking force of the towed vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a towing mode control system of a vehicle configured for preventing, in the case of heavy-weight towing and towed vehicles, a lack of an acceleration and starting feeling of the vehicles by reducing regenerative torque of the towed vehicle compared to a basic control state of a flat tow mode, and a method therefor.

In one aspect, the present disclosure provides a towing mode control system of a vehicle including a driving information detector configured to detect, while a towing vehicle is towing a towed vehicle in a state where the towing vehicle and the towed vehicle are connected by a towing device to communicate with each other by a communication device, vehicle driving information of the towing vehicle, in the towing vehicle, and a controller configured to receive the vehicle driving information of the towing vehicle transmitted from the towing vehicle and estimate a total weight of the towing vehicle and the towed vehicle based on the vehicle driving information of the towing vehicle and vehicle driving information of the towed vehicle, in which the controller is configured to adjust a motor regenerative torque of the towed vehicle according to the estimated total weight during towing of the towed vehicle.

In an exemplary embodiment of the present disclosure, the towing mode control system may further include a driving information detector configured to detect the vehicle driving information of the towed vehicle, in the towed vehicle.

In another exemplary embodiment of the present disclosure, the controller may be configured to determine whether a weight estimation condition is satisfied based on one or both of the vehicle driving information of the towing vehicle and the vehicle driving information of the towed vehicle, and estimate the total weight of the towing vehicle and the towed vehicle in a case where a determination is made that the weight estimation condition is satisfied.

In yet another exemplary embodiment of the present disclosure, the vehicle driving information of the towing vehicle and the vehicle driving information of the towed vehicle for determining whether the weight estimation condition is satisfied may include a steering angle, a gradient of a traveling road, a vehicle speed, and a vehicle longitudinal acceleration.

In yet another exemplary embodiment of the present disclosure, the weight estimation condition may include a vehicle straight traveling condition in which the steering angle is within a set range, a vehicle flat road traveling condition in which the gradient is within a set range, a condition in which the vehicle speed is greater than or equal to a set vehicle speed, and a condition in which the vehicle longitudinal acceleration is greater than or equal to a set acceleration.

In still yet another exemplary embodiment of the present disclosure, the controller may be configured to determine that the weight estimation condition is satisfied, in a case where the steering angle, the gradient, the vehicle speed and the vehicle longitudinal acceleration detected from one of the towing vehicle and the towed vehicle satisfy the conditions or in a case where the steering angles, the gradients, the vehicle speeds, and the vehicle longitudinal accelerations detected from both of the towing vehicle and the towed vehicle satisfy the conditions.

In a further exemplary embodiment of the present disclosure, the controller may be configured to determine that the weight estimation condition is satisfied, in a case where an average of the steering angles detected from the towing vehicle and the towed vehicle, an average of the gradients detected from the towing vehicle and the towed vehicle, an average of the vehicle speeds detected from the towing vehicle and the towed vehicle, and an average of the vehicle longitudinal accelerations of the towing vehicle and the towed vehicle satisfy the conditions.

In another further exemplary embodiment of the present disclosure, the controller may be configured to determine a value obtained by dividing a total wheel driving force of the towing vehicle and the towed vehicle by a vehicle longitudinal acceleration, as the total weight of the towing vehicle and the towed vehicle.

In yet another further exemplary embodiment of the present disclosure, the vehicle driving information of the towing vehicle and the vehicle driving information of the towed vehicle for estimating the total weight may include a wheel torque and a tire dynamic radius of the towing vehicle, a wheel torque and a tire dynamic radius of the towed vehicle, and a vehicle longitudinal acceleration of one of the towing vehicle and the towed vehicle or an average of the vehicle longitudinal accelerations of the towing vehicle and the towed vehicle.

In yet another further exemplary embodiment of the present disclosure, the wheel torque of the towing vehicle may be a driving wheel torque, the wheel torque of the towed vehicle may be a regenerative wheel torque, and the controller may be configured to determine the total weight of the towing vehicle and the towed vehicle according to an expression “{(driving wheel torque/tire dynamic radius of towing vehicle)+(regenerative wheel torque/tire dynamic radius of towed vehicle)}/vehicle longitudinal acceleration=total weight”.

In still yet another further exemplary embodiment of the present disclosure, the controller may compare the total weight of the towing vehicle and the towed vehicle with a set weight to determine a weight excess amount, which is a value obtained by subtracting the set weight from the total weight, correct a preset regenerative torque based on the determined weight excess amount, and control a motor regenerative operation of the towed vehicle with the corrected regenerative torque.

In a still further exemplary embodiment of the present disclosure, the controller may be configured to determine a correction factor corresponding to the determined weight excess amount, and correct the preset regenerative torque by multiplying the preset regenerative torque by the determined correction factor.

In a yet still further exemplary embodiment of the present disclosure, the controller may be configured to determine the corrected regenerative torque as a smaller value as the weight excess amount becomes larger.

In another aspect, the present disclosure provides a towing mode control method of a vehicle including transmitting, in a state where a towing vehicle and a towed vehicle are connected by a towing device to communicate with each other by a communication device, vehicle driving information from the towing vehicle to the towed vehicle while the towing vehicle is towing the towed vehicle, estimating a total weight of the towing vehicle and the towed vehicle based on the vehicle driving information of the towing vehicle received from the towing vehicle and vehicle driving information of the towed vehicle, by a controller provided in the towed vehicle, and adjusting a motor regenerative torque of the towed vehicle according to the estimated total weight during towing of the towed vehicle, by the controller.

In an exemplary embodiment of the present disclosure, the towing mode control method may further include determining whether a weight estimation condition is satisfied based on one or both of the vehicle driving information of the towing vehicle and the vehicle driving information of the towed vehicle, by the controller, in which the controller may perform estimation of the total weight of the towing vehicle and the towed vehicle in a case where a determination is made that the weight estimation condition is satisfied.

In yet another exemplary embodiment of the present disclosure, the vehicle driving information of the towing vehicle for determining whether the weight estimation condition is satisfied may include a steering angle, a gradient of a traveling road, a vehicle speed, and a vehicle longitudinal acceleration.

In yet another exemplary embodiment of the present disclosure, the weight estimation condition may include a vehicle straight traveling condition in which the steering angle is within a set range, a vehicle flat road traveling condition in which the gradient is within a set range, a condition in which the vehicle speed is greater than or equal to a set vehicle speed, and a condition in which the vehicle longitudinal acceleration is greater than or equal to a set acceleration.

In still yet another exemplary embodiment of the present disclosure, the vehicle driving information of the towing vehicle and the vehicle driving information of the towed vehicle for estimating the total weight may include a wheel torque and a tire dynamic radius of the towing vehicle, a wheel torque and a tire dynamic radius of the towed vehicle, and a vehicle longitudinal acceleration of one of the towing vehicle and the towed vehicle or an average of the vehicle longitudinal accelerations of the towing vehicle and the towed vehicle.

In a further exemplary embodiment of the present disclosure, the adjusting of the regenerative torque of the towed vehicle may include comparing the total weight of the towing vehicle and the towed vehicle with a set weight to determine a weight excess amount, which is a value obtained by subtracting the set weight from the total weight, correcting a preset regenerative torque based on the determined weight excess amount, and controlling a motor regenerative operation of the towed vehicle with the corrected regenerative torque, by the controller.

In another further exemplary embodiment of the present disclosure, the controller may be configured to determine the corrected regenerative torque as a smaller value as the weight excess amount becomes larger.

Other aspects and exemplary embodiments of the present disclosure are discussed infra.

It is to be understood that the term “vehicle” or other similar terms as used herein are inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both electricity and gasoline.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a diagram illustrating a state in which towing charging of an electric vehicle (EV) is performed during towing in a flat tow mode;

FIG. 2 is a diagram showing a towing vehicle and a towed vehicle during towing charging according to an exemplary embodiment of the present disclosure;

FIG. 3 is a diagram illustrating a configuration of a system for performing a towing mode control process of a vehicle according to the exemplary embodiment of the present disclosure; and

FIG. 4 is a flowchart showing a towing mode control process of a vehicle according to an exemplary embodiment of the present disclosure.

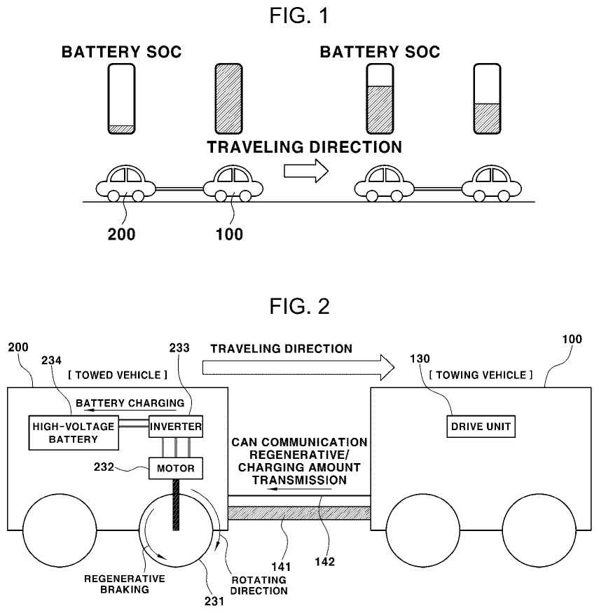

It should be understood that the appended drawings are not necessarily to scale, presenting a somewhat simplified representation of various exemplary features illustrative of the basic principles of the present disclosure. The specific design features of the present disclosure as included herein, including, for example, predetermined dimensions, orientations, locations, and shapes will be determined in part by the particular intended application and use environment.

In the figures, reference numbers refer to the same or equivalent portions of the present disclosure throughout the several figures of the drawing.

### DETAILED DESCRIPTION

Hereinafter, various exemplary embodiments of the present disclosure will be described in detail with reference to the accompanying drawings. Specific structural or functional descriptions presented in the exemplary embodiments of the present disclosure are merely exemplified for describing embodiments according to the concept of the present disclosure, and embodiments according to the concept of the present disclosure may be implemented in various forms. Furthermore, the present disclosure should not be construed as limited to the exemplary embodiments described in the present specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and similarly, a second element may be termed a first element, without departing from the scope of the exemplary embodiments of the present disclosure.

Furthermore, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the drawings to refer to the same or like parts. The terminology used herein is for describing various exemplary embodiments only and is not intended to limit exemplary embodiments of the present disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure relates to a towing mode control method of a vehicle, and to a towing charging control method configured for solving the conventional problem of insufficient driving force by adjusting and differentiating a regenerative torque in the towed vehicle according to a total weight of the vehicles while driving in a flat tow mode, in a case where the weights of a towing vehicle and a towed vehicle are large.

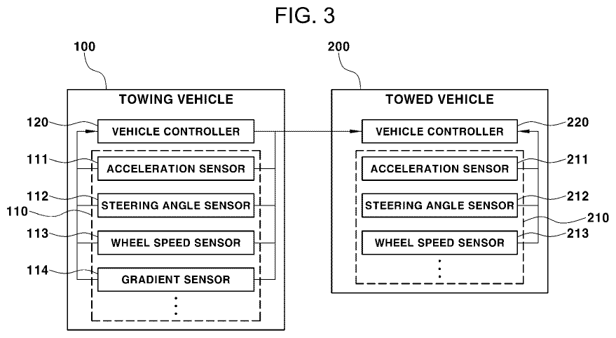

FIG. 2 is a diagram showing a towing vehicle and a towed vehicle during towing charging according to an exemplary embodiment of the present disclosure, and FIG. 3 is a diagram showing a configuration of a system for performing a towing mode control process of a vehicle according to the exemplary embodiment of the present disclosure.

Referring to FIG. 2, driving wheels 231 of a towed vehicle 200, a motor 232 connected to the driving wheels 231 for power transmission, an inverter 233 for driving and controlling the motor 232, and a battery 234 connected to the motor 232 to be charged and discharged via the inverter 233 are shown.

As shown in FIG. 2, in a state where a towing vehicle 100 and the towed vehicle 200 are connected by a towing device 141 such as a tow bar and a communication device 142 such as a communication cable, in a case where the towed vehicle 200 is towed in a flat tow mode, the battery 234 of the towed vehicle 200 may be charged by regenerative braking by the motor 232.

In an exemplary embodiment of the present disclosure, the towed vehicle 200 may be an eco-friendly vehicle configured for performing a regenerative mode by the motor 232, and may be an electric vehicle (EV) which is provided with the motor 232 which is a drive unit for driving the vehicle and operates the motor 232 with power from the battery 234 to drive the vehicle with a driving force generated by the motor.

In the case of the electric vehicle, the battery 234 may be charged through regenerative braking by the motor 232 during towing in the flat tow mode.

In an exemplary embodiment of the present disclosure, the towing vehicle 100 may be applied without limitation to any vehicle provided with a drive unit 130 and configured for being moved by driving force generated by the drive unit 130, such as an electric vehicle or an internal combustion engine vehicle.

In a state where the towing vehicle 100 and the towed vehicle 200 are connected by the towing device 141 such as a tow bar and the two vehicles 100 and 200 are traveling in the towing mode, particularly in the flat tow mode, in a case where EV towing charging for charging the battery 234 of the electric vehicle (EV) which is the towed vehicle 200 is performed by regenerative braking of the towed vehicle, an acceleration and starting feeling and a driving force may vary depending on the weights of the towing vehicle 100 and the towed vehicle 200.

During towing using the towing vehicle 100 which is heavy in weight compared to its driving force, the combined acceleration performance of the vehicles may be significantly reduced due to the regenerative braking force generated in the towed vehicle 200 during towing charging.

Accordingly, a flat tow mode and an EV towing charging control method configured for preventing the phenomenon of the insufficient acceleration and starting feeling, and driving force of the vehicle even when towing the towed vehicle 200 with the flat tow mode and the towing charging mode activated using the heavy-weight towing vehicle 100 are necessary.

FIG. 3 shows a configuration of a system for performing the towing mode control according to the exemplary embodiment of the present disclosure. As shown in FIG. 3, the towing mode control system for performing the towing mode control according to an exemplary embodiment of the present disclosure may include a driving information detector 110 provided to detect real-time vehicle driving information in the towing vehicle 100, and a controller 120 for controlling the towing vehicle 100.

Furthermore, the towing mode control system according to an exemplary embodiment of the present disclosure may further include a driving information detector 210 provided to detect real-time vehicle driving information from the towed vehicle 200, and a controller 220 that is configured to perform control for towing charging of the towed vehicle 200.

Here, the driving information detector 110 of the towing vehicle 100 may include an acceleration sensor 111, a steering angle sensor 112, a wheel speed sensor 113, and a gradient sensor 114, and the driving information detector 210 of the towed vehicle 200 may include an acceleration sensor 211, a steering angle sensor 212, and a wheel speed sensor 213.

While driving in the towing mode, while the towed vehicle 200 is towed in the flat tow mode, the controller 120 of the towing vehicle 100 and the controller 220 of the towed vehicle 200 are connected for communication via a wired or wireless communication device.

Here, the controller (120 or 220) of each vehicle may be a vehicle control unit (VCU), which is a higher-level controller.

For example, in the towing vehicle 100 and the towed vehicle 200, the vehicle driving information detected and collected in real time from each vehicle is transmitted and received through CAN communication of a vehicle network. Here, the towing vehicle 100 and the towed vehicle 200 may be connected through the communication device 142 to enable communication of information and signals between the vehicle networks of both sides.

In the present way, in such a communication connection state, the vehicle driving information detected by each detector, i.e., information on an acceleration, a steering angle, a wheel speed, and a gradient, may be transmitted from the towing vehicle 100 to the towed vehicle 200 through the communication device 142. Furthermore, tire dynamic radius information, which is vehicle information, may be transmitted.

Here, the controller 220 of the towed vehicle 200 may receive the information output from the controller 120 of the towing vehicle 100 and the signals output from the acceleration sensor 111, the steering angle sensor 112, the wheel speed sensor 113, and the gradient sensor 114 of the towing vehicle 100 through the communication device 142.

Furthermore, the controller 220 of the towed vehicle 200 receives the signals from the acceleration sensor 211, the steering angle sensor 212, and the wheel speed sensor 213 provided in the towed vehicle 200.

The controller 120 of the towing vehicle 100 may output and transmit real-time driving torque information and tire dynamic radius information of the towing vehicle, and may output and transmit, as the driving torque information, torque command information of the drive unit (e.g., motor or engine) for driving the vehicle, i.e., driving torque command information for controlling the driving of the drive unit 230.

In the present way, the controller 220 of the towed vehicle 200 may receive real-time sensor information of both vehicles, specifically, the vehicle acceleration information detected by the acceleration sensors 111 and 211, the steering angle information detected by the steering angle sensors 112 and 212, and the wheel speed information detected by the wheel speed sensors 113 and 213, and may further receive gradient information of a traveling road from the towing vehicle 100.

In an exemplary embodiment of the present disclosure, with the driving torque information, the vehicle acceleration information detected by the acceleration sensors 111 and 211, the steering angle information detected by the steering angle sensors (SAS) 112 and 212, the wheel speed information detected by the wheel speed sensors 113 and 213, and the gradient information detected by the gradient sensor 114 may be referred to as vehicle driving information indicating a vehicle driving state.

In an exemplary embodiment of the present disclosure, the acceleration sensors 111 and 211 may be a longitudinal acceleration sensor, and the acceleration detected by the acceleration sensors 111 and 211 may be a longitudinal acceleration of the vehicle.

In an exemplary embodiment of the present disclosure, the signals of the wheel speed sensors 113 and 213 are used to obtain the vehicle speed information. Since a method of obtaining the vehicle speed information from the signals of the wheel speed sensors 113 and 213 is known in the art, description thereof will be omitted.

The driving torque information of the towing vehicle 100 is input to the controller 220 of the towed vehicle 200, and may be used to determine the driving wheel torque of the towing vehicle 100, and the wheel torque is used to estimate the vehicle weight together with the tire dynamic radius information and the longitudinal acceleration information.

In an exemplary embodiment of the present disclosure, the vehicle weight refers to a total weight which is the sum of the weight of the towing vehicle 100 and the weight of the towed vehicle 200, and the driving wheel torque of the towing vehicle 100 and the regenerative wheel torque of the towed vehicle 200 are used together to estimate the total weight of the towing vehicle 100 and the towed vehicle 200.

Since the regenerative braking control is performed for the towed vehicle 200 during the flat tow mode and the EV towing charging, the wheel torque of the towed vehicle 200 corresponds to regenerative wheel torque, and thus, information on the driving wheel torque of the towed vehicle 100 and the regenerative wheel torque of the towed vehicle 200 is used together to determine the total weight of the towed vehicle 100 and the towed vehicle 200.

The regenerative wheel torque of the towed vehicle 200 may be determined from the regenerative torque of the towed vehicle 200, and the regenerative torque may be torque command information determined for the regenerative braking control of the towed vehicle 200 as a motor torque under the regenerative braking control, i.e., a regenerative torque command for the motor 232.

The wheel torque of the vehicle is a torque applied to the driving wheel 131, and may be determined from a torque of the drive unit (engine or motor of the towing vehicle, motor of the towed vehicle), i.e., the driving torque of the towing vehicle 100 and the regenerative torque of the towed vehicle 200, using a gear ratio of the drive unit and the driving wheel.

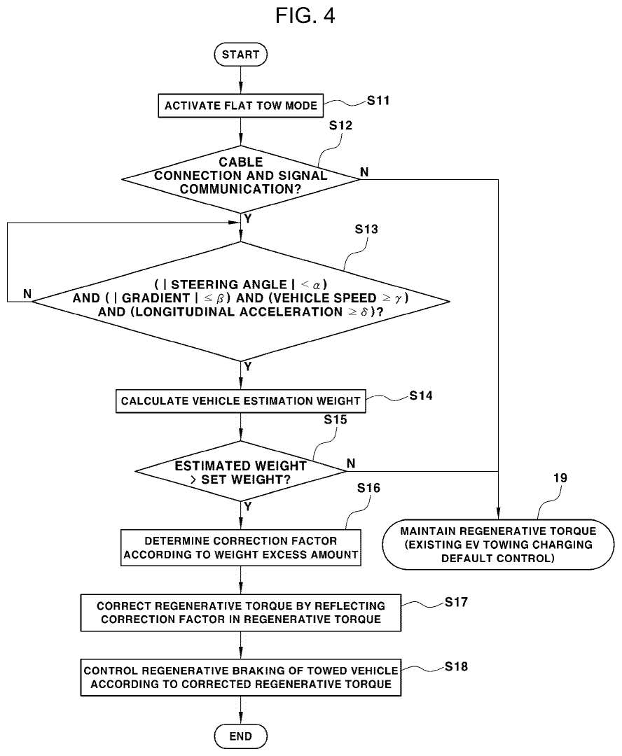

Hereinafter, the towing mode control and charging control process according to an exemplary embodiment of the present disclosure will be described in detail with reference to FIG. 4.

In an exemplary embodiment of the present disclosure, while an electric vehicle (EV) is towed in the flat tow mode, the towing charging control according to the vehicle weight, specifically, regenerative torque differentiation control according to the vehicle weight, is performed by the controller 220 of the towed vehicle 200.

A driver connects the towing vehicle 100 and the towed vehicle 200 through the towing device 141 such as a tow bar, turns on the engine of the towed vehicle 200 (“EV Ready”), selects the flat tow mode through the AVN, and sets a target State of Charge (SOC).

Then, in a case where the driver gets on the towing vehicle 100 and starts driving, the control for the flat tow mode is started and activated in the towed vehicle 200 (S11). The controller 220 of the towed vehicle 200 is configured to determine whether the EV towing charging mode is entered after the flat tow mode activation, and checks a communication state between the towed vehicle 100 and the towed vehicle 200 through a wired or wireless communication device to determine a connection state of the communication device 142, such as a communication cable, between the vehicles and a signal communication state (S12).

Here, the controller 220 of the towed vehicle 200 checks whether signals of the towing vehicle 100 indicating vehicle driving information, i.e., a steering angle signal, a wheel speed signal, a longitudinal acceleration signal, a gradient signal, and signals regarding a driving torque and a tire dynamic radius are being received. In a case where the above-mentioned signals are received from the towing vehicle 100, the controller 220 is configured to determine that the signal communication state between the vehicles is normal.

Then, the controller 220 of the towed vehicle 200 is configured to determine whether a current vehicle driving state satisfies a vehicle weight estimation condition based on the vehicle driving information obtained through the sensors of the towing vehicle 100 and the towed vehicle 200 (S13).

Here, in a case where the controller 220 of the towed vehicle 200 determines that the vehicle is traveling straight from the steering angle, determines that the vehicle is traveling on a flat road without a road gradient from the road gradient, determines that the vehicle speed is equal to or greater than a set speed, and determines that the vehicle longitudinal acceleration is equal to or greater than a set acceleration, the controller 220 may be configured to determine that the vehicle weight estimation condition is satisfied.

In estimating the vehicle weight, since the longitudinal force and longitudinal acceleration of the vehicle are referenced, it is necessary to measure the vehicle weight in a straight traveling situation with no lateral movement and when no force due to the road gradient acts on the vehicle.

To the present end, the steering angle and gradient information is used, and in a case where the steering angle is within a set range (|steering angle|≤α) in the straight traveling state and the road gradient is within a set range (|gradient|≤β) in the flat road traveling state, the controller 220 may be configured to determine that the vehicle weight estimation condition is satisfied.

Furthermore, when the vehicle does not move in a stopped state, the weight cannot be estimated, and therefore, the vehicle speed may be greater than or equal to a set vehicle speed (vehicle speed≥γ). Furthermore, the weight may be calculated using the force and longitudinal acceleration according to Newton's second law, but since the calculation is not possible in a case where there is no longitudinal acceleration, the controller 220 may be configured to determine that the vehicle weight estimation condition is satisfied in a case where the vehicle longitudinal acceleration is greater than or equal to a set acceleration (longitudinal acceleration≥δ).

In using the steering angle, vehicle speed, and longitudinal acceleration information as described above in the exemplary embodiment of the present disclosure, the controller 220 of the towed vehicle 200 may use real-time sensor detection information of one or both of the towing vehicle 100 and the towed vehicle 200, that is, the steering angle, vehicle speed (which may be obtained from a wheel speed signal), and longitudinal acceleration information of one or both of the two vehicles.

The vehicle estimation condition may include a straight traveling condition in which one of steering angles of the two vehicles is within the set range, a flat road traveling condition in which the road gradient is within the set range (condition with no road gradient), a condition in which one of the vehicle speeds of the two vehicles is equal to or lower than the set vehicle speed, and a condition in which one of longitudinal accelerations of the two vehicles is equal to or lower than the set acceleration.

Here, the road gradient may be detected by the gradient sensor of the towing vehicle as shown in FIG. 3, but instead, the gradient information detected by the gradient sensor of the towed vehicle may be used, or the gradient information detected by both the gradient sensor of the towing vehicle and the gradient sensor of the towed vehicle may be used.

Alternatively, the vehicle estimation condition may include a straight traveling condition in which the steering angles of both vehicles are within the set range, a flat road traveling condition in which the road gradient is within the set range (condition with no road gradient), a condition in which the vehicle speeds of both vehicles are equal to or lower than the set vehicle speed, and a condition in which the longitudinal accelerations of both vehicles are equal to or lower than the set acceleration.

Alternatively, an average steering angle of the two vehicles, an average speed of the two vehicles, and an average longitudinal acceleration of the two vehicles may be used.

That is, the vehicle estimation condition may include a condition in which the road gradient is within the set range (condition without no road gradient), a condition in which the average steering angle is within the set range (condition in which the vehicle is traveling straight), a condition in which the average vehicle speed is greater than or equal to the set vehicle speed, and a condition in which the average longitudinal acceleration is greater than or equal to the set acceleration.

In a case where the weight estimation condition is satisfied, the controller 220 of the towed vehicle 200 estimates the total weight of the towing vehicle 100 and the towed vehicle 200 based on the signals received from the towing vehicle 100, i.e., the information on the driving torque, the vehicle longitudinal acceleration, the tire dynamic radius, and the regenerative torque and tire dynamic radius of the towed vehicle 200 (S14).

Here, the controller 220 of the towed vehicle 200 is configured to determine a driving wheel torque of the towing vehicle from the driving torque of the towing vehicle 100, is configured to determine a regenerative wheel torque of the towed vehicle 200 from the regenerative torque of the towed vehicle 200, and then is configured to determine the total weight of the towed vehicle 100 and the towed vehicle 200 based on the driving wheel torque, regenerative wheel torque, tire dynamic radius, and vehicle longitudinal acceleration information.

In an exemplary embodiment of the present disclosure, the controller 220 of the towed vehicle 200 may be configured to determine the total wheel driving force (including the driving force and the regenerative braking force in the opposite direction to the driving force) of the towed vehicle 100 and the towed vehicle 200 using the driving wheel torque, the regenerative wheel torque, and the tire dynamic radius, and may be configured to determine the total weight of the towed vehicle 100 and the towed vehicle 200 using the determined wheel driving force and vehicle longitudinal acceleration.

In summary, the total weight of the towing vehicle 100 and the towed vehicle 200 may be determined by the following expression 1 from the driving wheel torque, the regenerative wheel torque, the tire dynamic radius, and the vehicle longitudinal acceleration.

Total weight of towing vehicle and towed vehicle={(driving wheel torque/tire dynamic radius of towing vehicle)+(regenerative wheel torque/tire dynamic radius of towed vehicle)}/vehicle longitudinal acceleration [Expression 1]

In the expression, “{(driving wheel torque/tire dynamic radius of towing vehicle)+(regenerative wheel torque/tire dynamic radius of towed vehicle)}” refers to the total wheel driving force applied to the wheels of both vehicles.

The vehicle longitudinal acceleration may be used to determine the vehicle weight by processing a longitudinal acceleration signal of the towing vehicle 100 and a longitudinal acceleration signal of the towed vehicle 200 to obtain a total longitudinal acceleration signal of all of the vehicles.

For example, in Expression 1, the vehicle longitudinal acceleration may be an average of the longitudinal acceleration of the towing vehicle 100 and the longitudinal acceleration of the towed vehicle 200, and the total weight of the vehicles may be determined using the total wheel driving force and the average longitudinal acceleration.

Alternatively, in Expression 1, one of the longitudinal acceleration of the towing vehicle 100 and the longitudinal acceleration of the towed vehicle 200 may be used as the longitudinal acceleration of the vehicle.

A value obtained by dividing the total wheel driving force by the average longitudinal acceleration is the total weight of the towing vehicle 100 and the towed vehicle 200.

After the weight is estimated as described above, the controller 220 of the towed vehicle 200 is configured to determine whether the estimated weight exceeds a preset weight (S15). In a case where the estimated weight exceeds the preset weight, the controller 220 of the towed vehicle 200 adjusts the regenerative torque of the towed vehicle 200 according to the estimated weight (S16, S17, and S18).

The controller 220 of the towed vehicle 200 compares the estimated weight with the set weight to determine the amount by which the estimated weight exceeds the set weight, i.e., the weight excess amount, which is a value obtained by subtracting the set weight from the estimated weight, and is configured to determine a correction factor using setting data based on the weight excess amount (S16).

Here, the setting data may be data that defines a correlation between the weight excess amount and the correction factor.

That is, the setting data may be data in which the correction factor is set according to the weight excess amount, for example, a table in which the correction factors are set according to the weight excess amounts. The setting data may be input and stored in advance in the controller 220 of the towed vehicle 200 and then used to determine the correction factor from the weight excess amount.

Accordingly, the controller 220 of the towed vehicle 200 adjusts the regenerative torque to a value obtained by applying the correction factor to a normal regenerative torque (preset regenerative torque, hereinafter defined as “basic regenerative torque”) used in EV towing charging in the flat tow mode.

In an exemplary embodiment of the present disclosure, the correction factor may be set to a value smaller than 1, and in the setting data, the larger the weight excess amount, the smaller the correction factor may be set.

Accordingly, the value obtained by applying the correction factor to the basic regenerative torque, that is, the regenerative torque obtained by multiplying the basic regenerative torque by the correction factor, becomes a value smaller than the basic regenerative torque, and thus, in an exemplary embodiment of the present disclosure, in a case where the estimated weight exceeds the set weight, control for reducing the regenerative torque of the towed vehicle 200 to become less than the basic regenerative torque may be performed.

The larger the weight excess amount, the greater the vehicle weight (total weight of the towing vehicle and the towed vehicle). As the vehicle weight increases, the acceleration and starting feeling may decrease. Accordingly, it is necessary to increase the amount of regenerative torque reduction in the towed vehicle 200.

Accordingly, in an exemplary embodiment of the present disclosure, a smaller correction factor value is used as the weight excess amount value increases, and the regenerative torque is corrected by multiplying the basic regenerative torque by the smaller correction factor value (S17).

Accordingly, the controller 220 of the towed vehicle 200 is configured to control the regenerative operation of the motor 232, which is the drive unit of the towed vehicle 200, using the corrected regenerative torque as a command value (S18, regenerative torque reduction control).

Using a smaller correction factor results in larger reduction in the regenerative torque relative to the basic regenerative torque, while the corrected regenerative torque becomes smaller. As a result, under the condition that the vehicle weight exceeds the set weight, the vehicle weight is inversely proportional to the correction factor, resulting in a smaller regenerative torque in the towed vehicle 200.

In the present way, the control for adjusting the regenerative torque of the towed vehicle 200 according to the vehicle weight, and more specifically, the control for reducing the regenerative torque of the towed vehicle 200 as the vehicle weight exceeds the set weight, is performed. Thus, it is possible to prevent the lack of the acceleration and starting feeling, and driving force from occurring due to excessive regenerative torque during EV towing charging.

Here, the controller 220 of the towed vehicle 200 is configured to perform the regenerative torque reduction control for adjusting the regenerative torque according to the vehicle weight, so that the high-voltage battery 234 of the towed vehicle 200 may be charged up to the target SoC.

Even though the flat tow mode is selected, in a case where there is no signal communication between the two vehicles or the estimated vehicle weight is determined to be less than or equal to the set weight, the controller 220 of the towed vehicle 200 is configured to perform the existing towing charging control, i.e., towing charge default control for controlling the regenerative braking of the towed vehicle 200 using the basic regenerative torque as a command value.

In the instant case, in the flat tow mode in which the towed vehicle 200 is towed by the towing vehicle 100, the controller 220 of the towed vehicle 200 enables the battery 234 of the towed vehicle 200 to be charged up to the target SoC through the normal EV towing charging control using basic regenerative torque.

Accordingly, according to the vehicle towing mode control method, in a case where the weights of the towing and towed vehicles are heavy, the regenerative torque reduction control is performed to reduce the regenerative torque of the towed vehicle compared to the basic control state of the flat tow mode, solving the problem of insufficient vehicle acceleration and starting feeling during the existing EV towing charging.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like. Furthermore, the computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A towing mode control system of a vehicle, the system comprising:
a driving information detector configured to detect vehicle driving information of a towing vehicle, in the towing vehicle, while the towing vehicle is towing a towed vehicle in a state where the towing vehicle and the towed vehicle are connected by a towing device to communicate with each other by a communication device; and
a controller configured to receive the vehicle driving information of the towing vehicle transmitted from the towing vehicle and estimate a total weight of the towing vehicle and the towed vehicle based on the vehicle driving information of the towing vehicle and vehicle driving information of the towed vehicle,
wherein the controller is configured to adjust a motor regenerative torque of the towed vehicle according to the estimated total weight during towing of the towed vehicle.

2. The towing mode control system of claim 1, further including a driving information detector configured to detect the vehicle driving information of the towed vehicle, in the towed vehicle.

3. The towing mode control system of claim 1, wherein the controller is further configured to determine whether a weight estimation condition is satisfied based on one or both of the vehicle driving information of the towing vehicle and the vehicle driving information of the towed vehicle, and to estimate the total weight of the towing vehicle and the towed vehicle in a case where the controller concludes that the weight estimation condition is satisfied.

4. The towing mode control system of claim 3, wherein the vehicle driving information of the towing vehicle and the vehicle driving information of the towed vehicle for determining whether the weight estimation condition is satisfied include a steering angle, a gradient of a traveling road, a vehicle speed, and a vehicle longitudinal acceleration.

5. The towing mode control system of claim 4, wherein the weight estimation condition includes:
a vehicle straight traveling condition in which the steering angle is within a set range;
a vehicle flat road traveling condition in which the gradient is within a set range;
a condition in which the vehicle speed is greater than or equal to a set vehicle speed; and
a condition in which the vehicle longitudinal acceleration is greater than or equal to a set acceleration.

6. The towing mode control system of claim 5, wherein the controller is further configured to determine that the weight estimation condition is satisfied, in a case where the steering angle, the gradient, the vehicle speed and the vehicle longitudinal acceleration detected from one of the towing vehicle and the towed vehicle satisfy the conditions or in a case where the steering angles, the gradients, the vehicle speeds, and the vehicle longitudinal accelerations detected from both of the towing vehicle and the towed vehicle satisfy the conditions.

7. The towing mode control system of claim 5, wherein the controller is further configured to determine that the weight estimation condition is satisfied, in a case where an average of the steering angles detected from the towing vehicle and the towed vehicle, an average of the gradients detected from the towing vehicle and the towed vehicle, an average of the vehicle speeds detected from the towing vehicle and the towed vehicle, and an average of the vehicle longitudinal accelerations of the towing vehicle and the towed vehicle satisfy the conditions.

8. The towing mode control system of claim 1, wherein the controller is further configured to determine a value obtained by dividing a total wheel driving force of the towing vehicle and the towed vehicle by a vehicle longitudinal acceleration, as the total weight of the towing vehicle and the towed vehicle.

9. The towing mode control system of claim 1, wherein the vehicle driving information of the towing vehicle and the vehicle driving information of the towed vehicle for estimating the total weight includes a wheel torque and a tire dynamic radius of the towing vehicle, a wheel torque and a tire dynamic radius of the towed vehicle, and a vehicle longitudinal acceleration of one of the towing vehicle and the towed vehicle or an average of the vehicle longitudinal accelerations of the towing vehicle and the towed vehicle.

10. The towing mode control system of claim 9,
wherein the wheel torque of the towing vehicle is a driving wheel torque, and the wheel torque of the towed vehicle is a regenerative wheel torque, and
wherein the controller is further configured to determine the total weight of the towing vehicle and the towed vehicle according to an expression “{(driving wheel torque/tire dynamic radius of towing vehicle)+(regenerative wheel torque/tire dynamic radius of towed vehicle)}/vehicle longitudinal acceleration=total weight”.

11. The towing mode control system of claim 1, wherein the controller is further configured to compare the total weight of the towing vehicle and the towed vehicle with a set weight to determine a weight excess amount, which is a value obtained by subtracting the set weight from the total weight, to correct a preset regenerative torque based on the determined weight excess amount, and to control a motor regenerative operation of the towed vehicle with the corrected regenerative torque.

12. The towing mode control system of claim 11, wherein the controller is further configured to determine a correction factor corresponding to the determined weight excess amount, and to correct the preset regenerative torque by multiplying the preset regenerative torque by the determined correction factor.

13. The towing mode control system of claim 11, wherein the controller is further configured to determine the corrected regenerative torque as a smaller value as the weight excess amount becomes larger.

14. A towing mode control method of a vehicle, the method comprising:
transmitting vehicle driving information from a towing vehicle to a towed vehicle while the towing vehicle is towing the towed vehicle, in a state where the towing vehicle and the towed vehicle are connected by a towing device to communicate with each other by a communication device;
estimating a total weight of the towing vehicle and the towed vehicle based on the vehicle driving information of the towing vehicle received from the towing vehicle and vehicle driving information of the towed vehicle, by a controller provided in the towed vehicle, and
adjusting a motor regenerative torque of the towed vehicle according to the estimated total weight during towing of the towed vehicle, by the controller.

15. The towing mode control method of claim 14, further including:
determining, by the controller, whether a weight estimation condition is satisfied based on one or both of the vehicle driving information of the towing vehicle and the vehicle driving information of the towed vehicle,
wherein the controller is configured to perform estimation of the total weight of the towing vehicle and the towed vehicle in a case where the controller concludes that the weight estimation condition is satisfied.

16. The towing mode control method of claim 15, wherein the vehicle driving information of the towing vehicle for determining whether the weight estimation condition is satisfied includes a steering angle, a gradient of a traveling road, a vehicle speed, and a vehicle longitudinal acceleration.

17. The towing mode control method of claim 16, wherein the weight estimation condition includes:
a vehicle straight traveling condition in which the steering angle is within a set range;
a vehicle flat road traveling condition in which the gradient is within a set range;
a condition in which the vehicle speed is greater than or equal to a set vehicle speed; and
a condition in which the vehicle longitudinal acceleration is greater than or equal to a set acceleration.

18. The towing mode control method of claim 14, wherein the vehicle driving information of the towing vehicle and the vehicle driving information of the towed vehicle for estimating the total weight include a wheel torque and a tire dynamic radius of the towing vehicle, a wheel torque and a tire dynamic radius of the towed vehicle, and a vehicle longitudinal acceleration of one of the towing vehicle and the towed vehicle or an average of the vehicle longitudinal accelerations of the towing vehicle and the towed vehicle.

19. The towing mode control method of claim 14, wherein the adjusting of the regenerative torque of the towed vehicle includes:
comparing the total weight of the towing vehicle and the towed vehicle with a set weight to determine a weight excess amount, which is a value obtained by subtracting the set weight from the total weight;
correcting a preset regenerative torque based on the determined weight excess amount; and
controlling a motor regenerative operation of the towed vehicle with the corrected regenerative torque, by the controller.

20. The towing mode control method of claim 19, wherein the controller is configured to determine the corrected regenerative torque as a smaller value as the weight excess amount becomes larger.
